(19) United States
(12) Patent Application Publication
(10) Pub. No.: US 2006/0152358 A1
(43) Pub. Date: Jul. 13, 2006

(54) Bed-exit monitoring method and apparatus

(76) Inventor: Josef Osterweil, Rockville, MD (US)

Correspondence Address: JOSEF OSTERWEIL, 5411 AMBERWOOD LANE, ROCKVILLE, MD, 20853, US

(21) Appl. No.: 11/326,328

(22) Filed: Jan. 6, 2006

Related U.S. Application Data
(60) Provisional application No. 60/641,884, filed on Jan. 7, 2005.

(51) Int. Cl. G08B 1/08

(52) U.S. Cl. 340/539.13

(57) ABSTRACT

The invention of a new patient movement sensor for bed, wheelchair, chair, etc., exit monitor is comprised of a tether made of lanyard such as is used for identification badge holders. The use of such lanyard allows for a selection of color varieties that can be imprinted with a logo, company name, message, etc. The lanyard tether can be used as a fixed length tether or a variable length tether. The tether length-control is not comprised of a loop for safety reasons. The invention is also comprised of a sensor (typically a balanced magnetic with a ferromagnetic shunt that is attached to the tether). Another feature of the invention is the use of signaling communications and voice communications enabling verbal communication between the caregiver and the alarm-site (resident).

### RELATED DATA

The present application expressly incorporates by reference herein the entire disclosure of U.S. Provisional Application No. 60/641,884, entitled “Bed-Exit Monitoring Method and Apparatus”, which was filed on Jan. 7, 2003.

### FIELD OF INVENTION

Bed-exit monitoring of frail and confused elderly has been prevalent in nursing home settings since the official discouragement by OBRA of the use of physical or chemical restraints for residents. The objective of such monitoring is to alert nursing staff that a resident bed-exit is being attempted or has already been executed. In such case, the staff is expected to rush to the site and provide assistance to the resident so as to prevent a fall. If a fall has already occurred, the staff must provide assistance and appropriate care.

An ultimate monitor would be a resident-mind-reader determining when a resident planned to attempt an exit so that help could be there when it was needed. In realistic terms, a detection of the earliest signs of attempted exit has the best chance of averting a fall by the immediate response of staff to the alert of such bed-exit attempt.

Bed-exit monitoring is used as a generic term associated with at least bed, chair, wheelchair, and toilet exit monitoring.

The objectives of a bed-exit sensor, in order of priorities, are as follows:
Resident safety. The sensor's presence and operation must not pose any danger to the resident.
Resident comfort. A sensor that is uncomfortable to the resident and/or has an agitating impact on the resident, should not be considered
Earliest possible exit attempt detection. Exit falls can generally be prevented with early staff alert.
Immune to resident's circumvention of the monitoring process. Monitors should not be easily disabled by the resident.
Few false alarms. Although it is preferable to have a false alarm than no alarm at all, many false alarms are taxing to the nursing staff and thus increase the cost of care. At the same time, excessive false alarms dull the staffs sense of response urgency.
User friendly. Exit monitoring should require minimum involvement by the nursing staff. Actions required by the nursing staff must be prompted and clearly verified upon completion.
Self-check and malfunction alert. A monitor with low battery does not work. Less obvious malfunctions also render a monitor as useless.
High product reliability with minimal maintenance and hygiene issues. Cleaning requirements, frequency of parts replacement, field adjustments, etc., need careful consideration.
Operation concepts should be self-evident and intuitive to staff. Improper monitor implementation gives a false sense of security.

### DESCRIPTION OF PRIOR ART

The most popular technologies used in bed-exit monitoring include the following:

Pressure sensing

Tether defined area-of-motion sensing

Pressure Sensing

Pressure-mat sensing was pioneered by BedCheck and has over the years been offered by other manufacturers. A pressure-sensitive mat is placed on the bed under the resident's body. A decrease of pressure sensed by the mat is interpreted as an exit attempt and, consequently, an alert condition is initiated. This approach is sensitive to resident movement, such as tossing and turning, in the bed (chair, etc.). This problem is typically overcome by an alarm delay of several seconds (user selectable in many cases) that reduces the number of false alarms. However, the consequences of a delay in setting up the alert condition increases the risk of resident fall since staff response has been correspondingly delayed.

Mats require regular replacement due to hygiene issues, thus adding continuous cost. An alternative to the mat (used by some bed manufacturers) uses a built-in pressure sensor system within the bed (or mattress) which eliminates hygiene issues.

The pressure sensing approach, although it retains popularity, is not very definitive in its operational parameters and its proper operation is not as intuitively obvious to the nursing staff as other approaches. As a result, the staff may get a false sense of security due to excessive alarm setting, mat placement, or other parametric settings.

Tether Defined Area-of-Motion Sensing

The tether allowed area-of-movement sensing approach is based on a predetermined length of cord (tether) between the resident's garment and the sensing device. The tether is loosely retained by the sensing device and is disengaged when the resident exceeds the designated radius of motion defined by the tether length. The alert condition is set when the tether disengages from the sensing device. The length of tether clearly defines the allowed area of movement as a radius of motion and is therefore user friendly. Over the years many versions of the tether sensor have been introduced to the market. They vary in the retention mechanism of the tether by the sensor. The original Vigil 88 (now Tabs) uses magnetic tether retention where the sensor contains the magnet(s) and the tether is terminated with a dime size metal disc. This disc is safe for the resident because of its small size and light weight, no mater at what speed it is extracted from the magnetic retention. Since the retention is magnetic, the extraction can occur from any angle as determined by the resident's motion.

In some other versions offered as magnetic retention, the magnet itself is attached to the tether and exposes the resident to the danger of being hit by the magnet (larger and heavier than the disc described above). Others offer a mechanical retention which is unreliable since its extraction force is difficult to control and which is also susceptible to malfunction and, as a result, to contamination. Yet others offer an adjustable tether at the risk of having the adjusting loop caught by some object (bed post chair . . . ) and injuring the resident in the process.

### SUMMARY OF THE INVENTION

One advantage of the invention is a tether that is comprised of a flat ribbon, lanyard, or strap as is used for identification badge holders, etc. The use of such lanyard allows for a selection of color varieties that can be imprinted with a logo, company name, message, etc. A brightly colored lanyard will help the user to locate it from among, for instance, the bed linen.

Another advantage of the invention is the use of the lanyard tether material for at least one of a fixed length tether and a variable length tether.

Yet another advantage of the invention is the use of an open-tether length-control that is not comprised of a loop. This approach is usable with any tether cross-section, such as, but not limited to, flat and oval and round tether material.

Another advantage of the invention is the use of a magnetic shunt that is attached to the tether by at least one of crimping, clamping, and gluing.

Another advantage of the invention is the use of a clip that is attached to the tether by at least one of crimping, clamping, and gluing.

Another advantage of the invention is the use of a clip that is attached to the tether by use of a buckle.

Another advantage of the invention is the narrow, elongated shape and reduced size of the shunt.

Another advantage of the invention is the use of a magnetic sensor.

Another advantage of the invention is the use of a magnetic sensor that allows tether detachment from any direction with a consistent range of threshold detachment force.

Another advantage of the invention is its interface with other sensors such as pressure mat.

Another advantage of the invention is the use of at least one of a signaling communication identifying the alarm source and a voice communication enabling verbal communication between the caregiver and the alarm-site (resident).

Another advantage of the invention is the use of at least one of a signaling communication with acknowledgment from the caregiver site and a signaling communication without acknowledgment from the caregiver site.

Another advantage of the invention is the use of alarm-condition electronic emanations from the sensor to track the location of the sensor.

Another advantage of the invention is the use of an audible sensor alarm.

### BRIEF DESCRIPTION OF THE DRAWINGS

The following drawings are:

FIG. 1a illustrates an integrated clip and buckle for use with variable length tether.

FIG. 1b illustrates the integrated clip-buckle-tether attachment for a variable length tether.

FIG. 2a illustrates a buckle for use with a variable length tether.

FIG. 2b illustrates a clip-buckle-tether attachment for a variable length tether.

FIG. 3a illustrates another buckle for use with a variable length tether.

FIG. 3b illustrates a clip riveted to the buckle with attached tether for a variable length tether.

FIG. 4 illustrates a standard clip attached to the tether by a knot in the tether.

FIG. 5 illustrates a shunt crimped to the tether.

FIG. 6 illustrates a shunt glued to the tether.

FIG. 7 illustrates the clip, shunt, and variable length tether assembly while the shunt is attached to a magnetic sensor.

FIG. 8 illustrates the magnetic sensor enclosed in a sensor case.

FIG. 9 illustrates the controller reading the status of the magnetic sensor and auxiliary sensor while controlling local alarm and remote communications.

FIG. 10a illustrates a current art buckle used in a variable length tether.

FIG. 10b illustrates a current art variable length tether scheme.

### DETAILED DESCRIPTION OF THE EMBODIMENTS

An integrated clip 10 and buckle 12 is shown in FIG. 1a. The buckle is shown with three tether feed slots. However, this invention is not limited to a specific number of slots as long as the tether can be reliably attached to the clip while allowing an adjustable tether length. The clip is part of the tether assembly comprised of the tether, clip, and a shunt. The tether 14 is illustrated in FIG. 1b as a flat lanyard. FIG. 1b also shows a manner in which the tether 14 is attached to the buckle 12. The side view shows the tether split into two sections 14a and 14b as they part from the clip attachment buckle 12. Section 14a of the tether is terminated with a shunt which will be discussed later. Tether section 14b is represents the excess lanyard length after the tether length (between the clip and the shunt) has been established. Section 14b of the tether is left dangling which, as will be demonstrated later, has no adverse effect on the operation of the monitor or resident's comfort. The buckle can be substituted with a latch similar to those used on suspenders providing that it is designed to be dependable and does not cause resident discomfort.

FIG. 2a shows a separate buckle 22 that, in conjunction with a standard clip 20 (shown in FIG. 2b), is attached to the tether in a manner as to provide the same resulting tether length adjustability as in the description of FIGS. 1a and 1b.

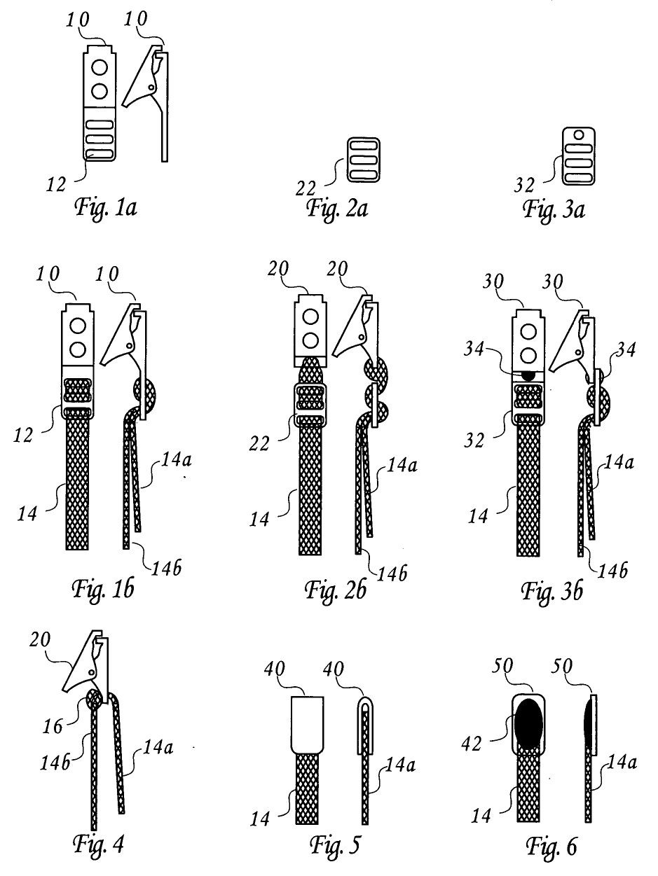

Similarly FIG. 3a shows a buckle 32 that is attached to a standard clip 30 (FIG. 3b) by a rivet 34 thus effectively acting as the example of FIGS. 1a and 1b. The attachment by a rivet is given as an example and it is understood that the invention is not limited to the rivet attachment method.

FIG. 4 illustrates one of the simplest attachments of the standard clip 20 to the tether 14a and 14b by the use of a knot 16 in the tether.

A magnetic shunt comprises a paramagnetic material such as soft iron, with enough surface and thickness for enabling retention of the shunt by the magnetic poles of the sensor. The magnetic shunt, when attached to the sensor, also modifies the path of magnetic flux in and around the sensor. FIG. 5 shows an example of a shunt 40 crimped onto the tether 14a. The shape of the shunt is elongated to minimize the potential of it being inadvertently caught by any object. The shunt shown is symmetrical and can be magnetically attached onto the sensor on both surfaces. This invention is not limited by a particular crimping approach or structure.

FIG. 6 shows a shunt attached to the tether by glue. This type of shunt can be magnetically attached to the sensor on one surface only. A shunt can be attached to the tether by means of a buckle (not shown with a shunt) as shown in FIGS. 1 through 4 and thus provide the tether length adjustment on the shunt end. The length adjustment can therefore be handled close to the clip or the shunt or both.

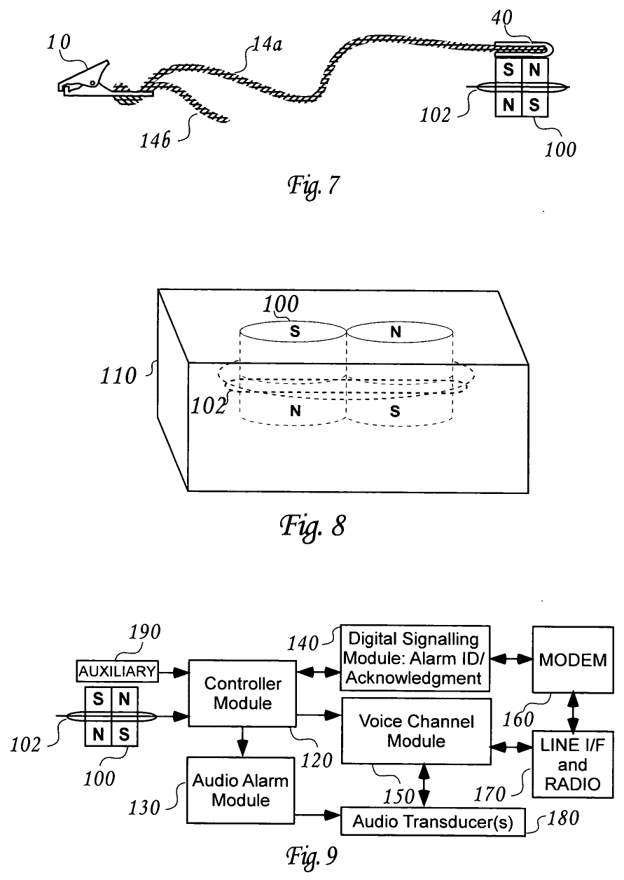

FIG. 7 illustrates an example of a clip 10, shunt 40, and variable length tether (14a and 14b) assembly while the shunt is attached to a magnetic sensor 100 per U.S. Pat. No. 8,313,724. Note that the tether segment 14a connects the shunt 40 to the clip 10 while the length of tether segment 14a determines the maximum distance between the clip 10 and the shunt 40. This length is defined by the allowed range of motion of the resident. Also, note that lanyard segment 14b is dangling freely without interference with the tether's functionality and is not likely to be caught by other objects. FIG. 7 also shows the output switch 102 of a typical sensor. Only one example configuration of the sensors from U.S. Pat. No. 8,313,724 is shown that can be configured for self-test and high reliability. However, this invention is not limited to any specific magnetic sensor within and/or outside U.S. Pat. No. 8,313,724. The flat lanyard tether has the benefit of being less obtrusive to the resident and can be ornamented with bright colors, company logo, and other messages. This invention is not limited to a flat lanyard. A cord with a round or other cross-section will function equally well.

This invention is not limited to a variable length tether. A fixed length tether (not shown) using any of the above attachment methods, in addition to sawing of the lanyard to the clip and the shunt, is an integral part of this invention.

FIG. 8 illustrates a typical sensor 100 per U.S. Pat. No. 8,313,724 as its N and S poles just barely protrude the face of an enclosure 110. This allows an easy shunt attachment without precise aiming and, more importantly, shunt detachment by a pull from any angle.

FIG. 9 shows the sensor 100 connected from the sensor switch 102 to a controller module 120. The controller module 120 coordinates the processing of the alert condition based on a predetermined sequence of events and staff response. For example, the controller module 120 can be as simple as a wire connecting the switch 102 to an annunciator or to a nurse-call system. The controller module 120 can also be microprocessors that control and interact will other elements. These elements include local audible alarm, signaling communication to the caregiver network, and voice communication between the caregiver and the resident.

Local audible alarm is triggered by the controller 120 by activating the audio alarm module 130 in conjunction with an audio transducer 180. Audio annunciators often come in an integrated driver and transducer form. This invention is not limited to a particular annunciator.

Signaling module 140 communication can be unidirectional when an acknowledgement is not required or bidirectional which includes acknowledgment and thus offers higher communication reliability. Signaling communication is used to provide digital information to the caregiver network and includes, but is not limited to, sensor identification code that provides a link to the resident in distress data. In case of a wheelchair, signaling can covey location information obtained from a tracking system.

A voice channel module 150 enables voice communications between the caregiver and the resident. The voice communication may add a sense of resident security in knowing that help is on its way and thus be a deterrent for unassisted exit from the bed, wheelchair, etc.

All communications, both signaling and voice, can be conveyed to the caregiver network by wire or wireless links. Depending on the type of caregiver's network, a type of modem 160 will be used for the signaling communications.

Wireless communications module (radio) 170 would preferably utilize the unlicensed (ISM band) but the scope of this invention is not limited to those spectrum bands. Neither is this invention limited to a specific modulation scheme such as AM, FM, Spread Spectrum, or spread time domain.

In all communications cases, wired, using the line interface (LINE I/F) 170 or wireless, using the radio 170, the system can be elected as one-way, half duplex and full duplex. All options provide exit monitoring service at respective levels with corresponding costs.

The Audio transducer(s) 180 are used both for voice communications and for local audible alarms. A speaker can accomplish both tasks; however, a separate transducer may be desired for a high decibel level alarm. In addition, a microphone is used for voice communications, particularly when full duplex communications is implemented.

The auxiliary interface 180 allows the controller to read the status of other sensors such as a pressure mat moisture detector in a diaper for incontinent residents, etc.

The implementation of the wired or the wireless communications can interface directly to an existing caregiver network. However, when caregiver network is incompatible with the implemented standards of the monitoring system, an independent network is implemented.

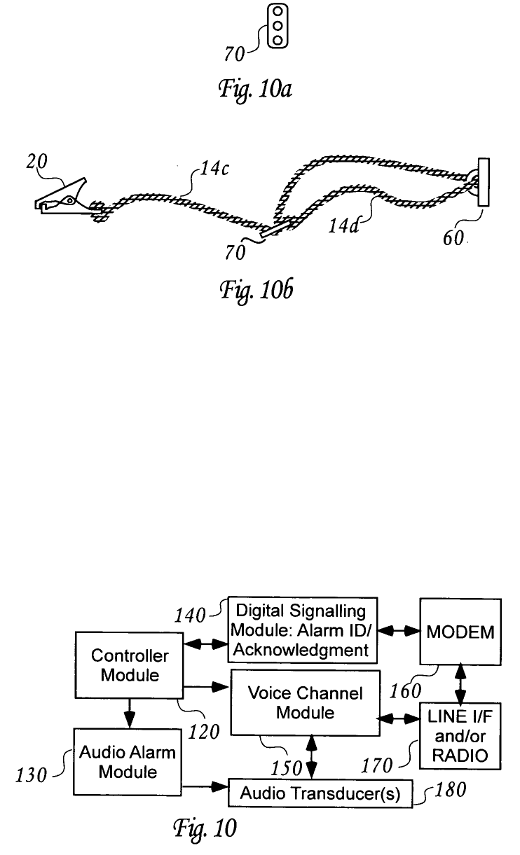

FIGS. 10a and 10b illustrate the current art variable length tether. The buckle 70 is typically used with a round cord (as offered by Posey's product) and the tether 14c includes the loop 14d that defines the maximal distance between the clip 20 and the magnet 60 (Posey). The loop 14d is an undesired feature that could put the resident in danger if it gets caught by an object. With a magnet 60 rather than a small shunt, the danger is even greater that the tether loop and magnet 60 can get entangled in some furniture/object on the resident's path and cause him to fall. Posey (the company) uses a buckle 70 made of soft leather so that the resident does not suffer pain when the buckle is lodged between him and the mattress.

I claim:

1. A method for sensing resident's motion such as exit attempt, comprising:
a) a tether of at least one of at least a flat ribbon, a lanyard, a lace and a strap of type used for identification badge holders where one of its ends is terminated so it can be attached to the sensor and the other end is terminated so it can be attached to the person being monitored;
b) of sensing the tether's terminal proximity to the sensor and distinguishing between tether's attached and detached status; and
c) of communicating between the sensor and the caregiver.

2. A method of claim 1 where the tether material is marked with at least one of a writing, a drawing and coloring.

3. A method of claim 2 where the tether markings convey at least one of a logo, a message and a tether length identification.

4. A method of claim 2 where the tether length is variable at one of the tether's terminations where the extra tether segment is free without creating a loop.

5. A method of claim 1 where the sensor's status is conveyed by at least one of a wired and a wireless means.

6. A method of claim 1 where the communications between sensor and the caregiver includes at least one of a voice communications and a message signaling communications.

7. A method of claim 1 where two-way communications is established between the caregiver and the sensor site.

8. A method of claim 1 where magnetic proximity sensing is implemented using a shunt as termination on one end of the tether attached by at least one of a gluing, a crimping and a clamping.

9. A method of claim 4 where the retention of the tether on the variable length end of the tether is a fastener like a buckle that is at least one of a separate entity from the tether's terminal and an integral part of the tether's terminal.

10. An apparatus that senses resident's motion such as exit attempt, comprising:
a) a tether of at least one of at least a flat ribbon, a lanyard, a lace and a strap of the type used for identification badge holders with terminations so that one end can be attached to the sensor and the other end can be attached to the person being monitored;
b) a proximity sensor for monitoring the tether's terminal and tether's attached/detached status output; and
c) a communication link between the sensor and the caregiver.

11. An apparatus of claim 10 where the tether material is marked with at least one of a writing, a drawing and coloring.

12. An apparatus of claim 11 where the tether markings convey at least one of a logo, a message and a tether length.

13. An apparatus of claim 11 where the tether length is variable at one of the tether's terminations where the extra tether segment is free without creating a loop.

14. An apparatus of claim 10 where the sensor's status is conveyed by at least one of a wired and a wireless means.

15. An apparatus of claim 10 where the communications between sensor and the caregiver includes at least one of a voice communications and a message signaling communications.

16. An apparatus of claim 10 where two-way communications is established between the caregiver and the sensor site.

17. An apparatus of claim 10 where magnetic proximity sensing is implemented using a shunt as termination on one end of the tether attached by at least one of a gluing, a crimping and a clamping.

18. An apparatus of claim 13 where the retention of the tether on the variable length end of the tether is a fastener like a buckle that is at least one of a separate entity from the tether's terminal and an integral part of the tether's terminal.

19. A method for sensing resident's motion such as exit attempt and location of the sensor within a facility, comprising:
a) a tether of at least one of at least a flat ribbon, a lanyard, a lace and a strap of type used for identification badge holders where one of its ends is terminated so it can be attached to the sensor and the other end is terminated so it can be attached to the person being monitored;
b) of sensing the tether's terminal proximity to the sensor and distinguishing between tether's attached and detached status;
c) of communicating between the sensor and the caregiver; and
d) of a radio frequency position location.

20. A method of claim 19 where the location is accomplished by at least one of triangulation and application of external positioning systems such as satellite positioning systems.
